(19) United States
(12) Patent Application Publication
(10) Pub. No.: US 2006/0083964 A1
(43) Pub. Date: Apr. 20, 2006

(54) Energy conversion system as well as reformer device and fuel cell device therefore

(75) Inventors: Bernhard Edlinger, Augsburg (DE); Juergen Kammerer, Pfaffenhofen (DE); Peter Lamp, Kaufering (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/256,163

(22) Filed: Oct. 24, 2005

Related U.S. Application Data
(63) Continuation of application No. PCT/EP04/02073, filed on Mar. 2, 2004.

(30) Foreign Application Priority Data
Apr. 24, 2003 (DE) 10318495.3

(51) Int. Cl. H01M 8/04

(52) U.S. Cl. 429/17

(57) ABSTRACT

An energy conversion system is provided having a reformer device and a fuel cell device which is arranged behind the reformer device, the reformer device has at least one fuel feeding pipe and one air feeding pipe. The reformer device includes a reformer, wherein a reformate heat exchanger is arranged between the reformer and the fuel cell device. The reformate heat exchanger transfers heat from the hot reformate gas to a fluid in a fluid circulation system.

### CROSS-REFERENCE TO RELATED APPLICATIONS

This application is a continuation of PCT Application No. PCT/EP2004/002073 filed on Mar. 2, 2004 which claims priority to German Application 10318495.3 filed Apr. 24, 2003.

### BACKGROUND AND SUMMARY OF THE INVENTION

The invention relates to an energy conversion system, as well as a reformer device and a fuel cell device therefore, particularly for the conversion of chemical energy to electric power and thermal energy.

From the state of the art, auxiliary power units (APUs) are known, which are already being used in series production in airplanes (turbines having a generator), in commercial vehicles and ships (diesel engine having a generator), and in space travel (fuel cells). It is a characteristic of an auxiliary power unit that it can supply the electrical vehicle wiring with current independently of the actual drive assembly of the vehicle.

Known possibilities are, on the one hand, the drive of a generator by way of an assembly, which is independent of the engine based on internal combustion (diesel engine, Otto engine) or external combustion (Stirling engine, Rankine cycle) and, on the other hand, the use of a fuel cell. In addition, different types of fuel cells, such as membrane fuel cells, molten-carbonate fuel cells, and solid electrolyte fuel cells, are known which, in principle, can be used for an auxiliary power unit. Furthermore, reformers and gas purifying devices are also known which permit the generation of a synthesis gas from gasoline, diesel, methanol, natural gas or other higher hydrocarbons, which synthesis gas can be electrochemically converted to electric power in fuel cells.

Membrane fuel cells (PEMFC, DMFC) are operated at approximately, 80-100° C. and can convert only pure hydrogen, so that, in addition to the actual reformer, a high-expenditure gas purification is required. Solid electrolyte fuel cells (SOFCs) operate at 700-1,000° C. and, because of the higher operating temperature and their method of operation, are capable of converting different synthesis gases with lower purity requirements. This permits a relatively simple energy conversion system, for example, consisting of a reformation by means of partial oxidation (PQx reformer) and a solid electrolyte fuel cell.

Reformate not used in the fuel cell for producing current is burnt in a final purification of the exhaust gas. Waste heat, which was generated in the system during the partial oxidation in the reformer, during the chemical reaction in the fuel cell stack, and during the afterburning, is discharged from the system by means of the exhaust gas unless it is used within the system for preheating starting substances.

Systems of this type are known, but have the disadvantage that the achievable efficiency is not yet optimal and a relatively high fraction of the chemical energy fed to the system is emitted together with the exhaust gas in the form of thermal energy. Furthermore, known systems have the disadvantage that, with respect to their space requirement, they are not very adaptable to existing space conditions, so that high expenditures are required for the integration of such systems into narrow space conditions, for example, in a motor vehicle.

From European Patent document EP 0 797 367 B1, a fuel cell system with a utilization of the heat of the cathode gas, and a method of operating it are known. This document discloses a combination of a fuel cell element, particularly a solid oxide fuel cell element whose cathode-side exhaust gas is guided, via a heat exchanger, in order to supply heat to the cathode-side unburnt gas. Subsequently, the cathode exhaust gas is supplied partially by way of another heat exchanger to a high-pressure side of a gas turbine in order to convert a portion of the energy content contained in the cathode exhaust gas to kinetic energy. This kinetic energy is then used for supply pumps of the system; for example, for the delivery of air or cathode exhaust gas. Furthermore, it is suggested that the kinetic energy, if required, be used for driving a generator.

In the case of this fuel cell system, it is a disadvantage that it does not have a very flexible construction with respect to its space requirement.

It is an object of the invention to provide an energy conversion system, which has an increased, that is, an optimized, overall efficiency and/or can easily be adapted to different and/or narrow space conditions.

It is another object of the invention to provide a reformer device, particularly for the energy conversion system, which may be operated as a reformer as well as a heating device and, in particular, my be continuously adjusted between these conditions.

It is yet another object of the invention to provide a fuel cell device, particularly for the energy conversion system, which may be operated at low gas temperatures, that is, at low temperatures of the reaction gases (starting gases) to be fed to the fuel cell. Furthermore, the fuel cell device according to the invention should have a low exhaust gas temperature (product gases).

The object concerning the energy conversion system is achieved by means of an energy conversion system having a reformer device and a fuel cell device, which is arranged behind the reformer device. The reformer device has at least one fuel feeding pipe and one air feeding pipe. The reformer device has a reformer. A reformate heat exchanger is arranged between the reformer and the fuel cell device, which reformate heat exchanger transfers heat from the hot reformate gas to a fluid.

The object concerning the reformer device is achieved by means of a reformer, a fuel feeding device, an air feeding device, and a reformate output. The reformer is followed by a reformate heat exchanger, which transfers heat from the reformate gas to a fluid in a fluid pipe.

The object concerning the fuel cell device is achieved by means of a fuel cell device having at least one fuel cell and one afterburning chamber arranged on the exhaust gas side behind an electrode of the fuel cell, for the afterburning of the electrode exhaust gas. A heat exchanger is connected behind the afterburning chamber, which heat exchanger transfers heat from exhaust gas leaving the afterburning chamber to a fresh electrode gas of the fuel cell.

A reformer device according to the invention may be operated as a reformer for a fuel cell device connected on the output side, as well as an auxiliary heater/additional heater. In this case, the combustion chamber of the reformer device is modified by the installation of a catalyst carrier, that is, a ceramic or metallic matrix, with an applied catalyst as well as the air, fuel and cooling water supply and its control, in such a manner that the conversion of the fuel and, thus, the synthesis gas and heat production of the reformer device may be freely selected within the limit values “complete combustion=maximal heat production” and “complete reformation=maximal synthesis gas production”. This means that the reformer device according to the invention operates optionally as an auxiliary heater/additional heater, or as a partial oxidation reformer (POx reformer), or as a mixture of the two.

Another preferred aspect of the reformer device according to the invention is that, in addition to gasoline or diesel and air, another medium, such as an anode exhaust gas from a solid electrolyte fuel cell or water vapor, can be fed.

Yet another preferred aspect of the reformer device according to the invention is that, in contrast to a POx reformer according to the state of the art, as a result of the special construction of the heat exchanger, which is an integral component of the reformer device, the synthesis gas (=reformate) exits at a typical reformate or exhaust gas temperature of approximately 300° C.-400° C., particularly 350° C. or below. The quantity of heat which the synthesis gas yields between the operating temperature of the reformation (temperature of the synthesis gas approximately 800° C.-1,050° C.) and the outlet temperature from the reformer device according to the invention (synthesis gas outlet temperature approximately 350° C.) is fed to the cooling water and may thereby be utilized, whereby the overall efficiency becomes high.

It is only the cooling of the reformate described according to the invention which makes it possible to cost-effectively and, at relatively low constructional expenditures, achieve an accommodation of the reformer device and of a pertaining fuel cell device or of the driving engine (particularly when operating as an engine preheating device), which is spatially separated in the vehicle and to thus implement a flexibility in packaging which is desirable for a flexible installation in a vehicle which can be adapted to different space conditions. It is also advantageous that only the installation space of an auxiliary heater or of an additional heater is required for the reformer device and the linking to the cooling water network may be maintained without any change with respect to an auxiliary heater/additional heater according to the state of the art.

A fuel cell device according to the invention is constructed as a current generating module and consists of a solid electrolyte fuel cell stack, an anode gas heat exchanger, and particularly a cathode air heat exchanger, in which case cold reformate, in particular, provided by the reformer device is heated by the heat of the anode exhaust gas in the anode gas heat exchanger to a temperature which allows an entry into the hot solid electrolyte fuel cell stack. The anode exhaust gas is simultaneously cooled to a temperature which permits a further distribution in the vehicle in a simple manner without the use of expensively insulated pipes made of high-temperature-resistant materials. This process may take place by means of the anode gas heat exchanger or an additional heat exchanger connected to the output side of the anode gas heat exchanger, the provision of the additional heat exchanger representing a preferred embodiment.

Furthermore, it is advantageous that the fuel cell device is further developed by a cathode air heat exchanger, which heats the cathode incoming air from the ambient temperature to a temperature allowing an entry into the hot solid electrolyte fuel cell stack and, thereby, utilizes the heat of the cathode exhaust air and/or of the exhaust gas generated during afterburning.

Furthermore, according to a particularly preferred embodiment of the cathode air heat exchanger, it is advantageous that the feeding of anode exhaust gas on the cathode gas outlet side of a fuel cell in front of the cathode gas heat exchanger and, thus, the complete conversion of still combustible constituents in the anode exhaust gas by means of the cathode air, becomes possible. For this purpose, a contemplated embodiment is provided in that the heat exchanger surfaces of the cathode exhaust air side are coated with a corresponding oxidation catalyst. It is a particularly advantageous embodiment of the invention that the anode gas heat exchanger, solid electrolyte fuel cell stack and cathode air heat exchanger components are partially, or in each case completely, combined into a unit and have a module-type construction. The provision of electric energy takes place by the electrochemical conversion of the reformate gas in the solid electrolyte fuel cell stack in an essentially known manner.

A reformer device according to the invention and a fuel cell device according to the invention are interconnected, according to the invention, to form an energy conversion device such that unburnt reformate gas, anode exhaust gas, as well as, if required, afterburning fresh air and cathode exhaust gas, may be fed to an afterburning chamber arranged behind the fuel cell device on the cathode side. For this purpose, it is provided that a first three-way valve is arranged in the pipe carrying unburnt reformate gas, and a second three-way valve is arranged in an anode exhaust gas pipe behind the anode gas heat exchanger and, if required, behind the additional heat exchanger, by which second three-way valve, one partial flow of the residual reformate gas can be branched off and fed to the afterburning chamber, while the other partial flow is fed to the reformer. As a result, the electric efficiency of the system increases. This arrangement has the advantage that, for example, during the starting operation of the energy conversion system, exhaust gas or reformate gas of a lower quality may be guided in the manner of a bypass around the solid electrolyte fuel cell stack, and the latter is thereby protected from possible damage. Likewise, reformate gas may advantageously be divided between the fuel cell stack and the cathode air heat exchanger. Particularly, in the case of a partial load, this ensures additional flexibility in the heat management of the cathode incoming air and of the fuel cell stack. In the case of systems according to the state of the art, the three-way valves in the unburnt reformate gas pipe and the anode exhaust gas pipe necessarily have to be constructed as so-called hot-gas valves because the gas temperatures of conventional reformer devices or fuel cell devices amount to approximately 700° C. to 900° C. in these areas.

In the case of an energy conversion system according to the invention having a reformer device according to the invention and a fuel cell device according to the invention, the temperatures in the area of the three-way valves are much lower and amount to approximately 300° C. or below, so that standard components can be used here, which considerably reduces the costs and the constructive expenditures. Furthermore, a gas delivery device may be arranged on the output side of the three-way valve in the anode exhaust gas pipe, that is, the residual reformate pipe, for overcoming the pressure loss between the anode exhaust gas side of the fuel cell device and the reformer devices. As a result of the circulation of the anode exhaust gas achieved thereby, the utilization of the chemical energy contained in the fuel and, thus, the electric efficiency and the overall efficiency can clearly be increased. In the arrangement according to the invention, the gas delivery device together with the pertaining three-way valve can also be constructed as standard components because the present gas temperatures amount to approximately 300° C. or less.

Other objects, advantages and novel features of the present invention will become apparent from the following detailed description of the invention when considered in conjunction with the accompanying drawings.

In the following, the invention will be explained by way of an example in conjunction with the drawings.

### BRIEF DESCRIPTION OF THE DRAWINGS

FIG. 1 is a schematic view of a first embodiment of the energy conversion system according to the invention having a reformer device and a fuel cell device according to the invention.

FIG. 2 is a schematic view of a second embodiment of the energy conversion system of the invention according to FIG. 1.

### DETAILED DESCRIPTION OF THE DRAWINGS

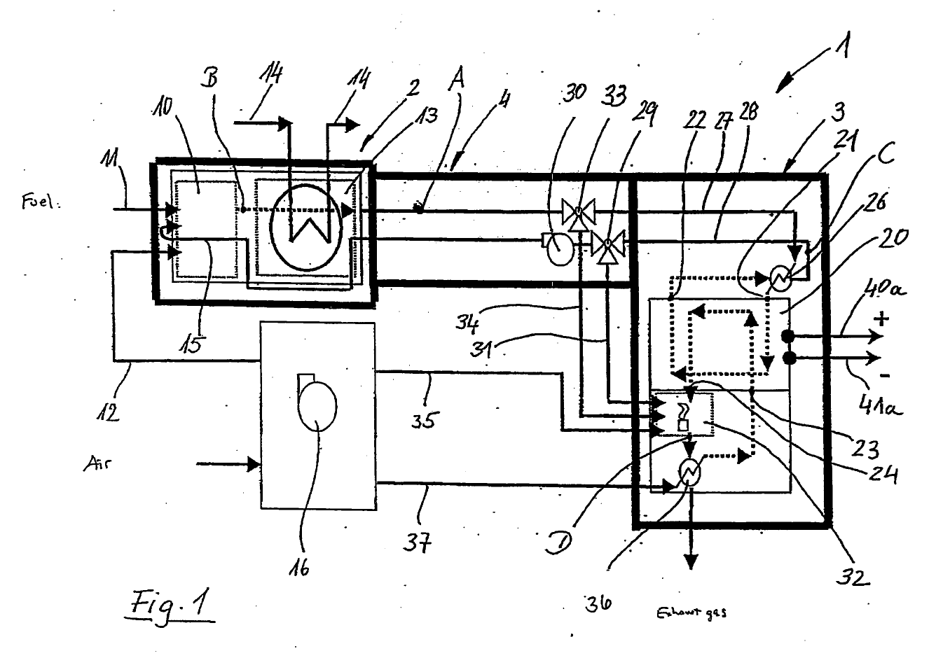

Referring to FIG. 1, an energy conversion system 1 according to the invention has a reformer device 2, a fuel cell device 3, and a distribution device 4.

The reformer device 2 according to the invention has an essentially known reformer 10 to which fuel can be fed by way of a fuel feeding pipe 11, and ambient air can be fed by of a fresh-air feeding pipe 12. The reformer 10 operates according to the catalytic principle; that is, the fuel is converted to a reformate gas along a reformer matrix on which a catalyst is situated.

Another possible method of operation of the reformer 10 is the conversion of the fuel and of the ambient air to the reformate gas by means of a so-called open combustion, which in the reformer operation normally takes place as a rich combustion, that is, with an excess of fuel.

Furthermore, the reformer device 2 has devices for adjusting the air/fuel ratio in the reformer 10. For example, these devices are constructed as a throttle valve in the fresh-air feeding pipe (not shown). In this case, the devices for adjusting the air/fuel ratio in the reformer 10 are designed such that the air/fuel ratio can be adjusted from a so-called rich mixture, that is, a mixture with an excess of fuel, having a lambda value of approximately λ0.3 to 0.35 to a stoichiometric ratio between the oxygen and the fuel, that is, a lambda value λ1. When the fuel with a lambda value of λ1 is burnt, a so-called rich combustion therefore takes place, so that the exhaust gas is present as reformate gas and contains hydrogen. At a lambda value of λ1 (stoichiometric air/fuel ratio), a so-called complete combustion is present so that, the exhaust gas leaving, the reformer 10 contains only CO2 and water and, therefore, essentially no reformate gas is present. Thus, in the range of low lambda values (λ0.3 to 0.35), the reformer 10 operates as a pure reformer, and in the range of the stoichiometric air/fuel ratio (λ1), it operates as a pure heater, any arbitrary intermediate operating point between the two extreme reformer and heater operating points being adjustable by the addition of fresh air.

Gas leaving the reformer 10, that is, reformate gas, exhaust gas, or a mixture thereof, is guided to a reformate gas heater exchanger 13 connected to the output side of the reformer 10 and flows through this reformate gas heat exchanger 13. In this case, heat is withdrawn from the reformate gas or the exhaust gas and is transferred to a fluid, such as a cooling water in a fluid pipe 14. Before the reformate gas reaches the reformats gas heat exchanger, it is present at a gas temperature of approximately 900-1,100° C. (point B). The reformate gas or the exhaust gas leaves the reformate gas heat exchanger 13 at a temperature of from 200-350° C. (point A).

Furthermore, the reformer 10 has a connection to which a residual reformate pipe 15 is connected. As described below, anode gas, which may possibly still contain residual constituents of the reformate, is transported in the residual reformate pipe 15. The residual constituents of reformate are admixed to the reformate gas in the reformer 10 or are converted to heat.

During the operation as a pure heater, the reformer device 10 only supplies exhaust gas at point A and provides a maximal amount of heat to the reformate gas heat exchanger 13, which maximal amount of heat is fed to the fluid in the fluid pipe 14. The reformer device 10, therefore, operates as a heater and can particularly be used in vehicles, for example, as an auxiliary heater or as an additional heater. The fresh-air feed pipe 12 is supplied with fresh air, for example, ambient air, by means of a blower 16.

A fuel cell device 3 according to the invention has at least one fuel cell, particularly at least one solid electrolyte fuel cell stack 20, which, in a known manner, has an anode gas inlet 21, an anode gas outlet 22, a cathode gas inlet 23, and a cathode gas outlet 24.

An anode gas heat exchanger 26, through which fresh reformate is fed by way of a fresh-reformate feeding pipe 27, is arranged in front of the anode gas inlet 21. By means of its second circuit, the anode gas heat exchanger 26 is connected with the anode gas outlet and, as a result, hot anode exhaust gas of a temperature of from 900-1,100° C. flows through the anode gas heat exchanger 26. The hot anode exhaust gas supplies heat to the relatively low-temperature unburnt anode gas, that is, the reformate gas from the reformer device 2, and heats it before its entry into the fuel cell 20. After flowing through the anode gas heat exchanger 26, the anode exhaust gas has a temperature of approximately 200-350° C. (point C). Behind the anode gas heat exchanger 26, the anode exhaust gas, may possibly contain residual reformate, is fed by way of a reformate return flow pipe 15, 28 via a first three-way valve 29 and, if required, a blower 30 to the reformer 10.

The first three-way valve 29 or the blower 30 alone permits the regulated and/or controlled branching-off of a partial flow of the residual reformate gas or of the anode exhaust gas into a first branch pipe 31, which is connected with an afterburning chamber 32 arranged behind the cathode gas outlet of the fuel cell 20.

A second three-way valve 33 is arranged in the fresh-reformate feeding pipe 27 in front of the anode gas heat exchanger 26, which three-way valve 33 is connected with the afterburning chamber 32 by way of a second branch pipe 34. By way of the second three-way valve 33, a partial flow of the fresh-reformate gas may be fed in a regulated and/or controlled manner by way of the second branch pipe 34 to the afterburning chamber 82. Furthermore, a fresh-air feeding pipe 36, if required, leads from the blower 16 to the afterburning chamber 32.

In the afterburning chamber 32, a cathode-side exhaust gas, which leaves the cathode gas outlet 24 of the fuel cell 20, if required, with a regulated and/or controlled addition of residual reformate by way of the branch pipe 81 and/or the regulated and/or controlled addition of fresh reformate by way of the branch pipe 34, is completely burnt, so that hot exhaust gas, which is free of fuel, is present behind the afterburning chamber 32 (point D).

A cathode gas heat exchanger is arranged on the exhaust gas side behind the afterburning chamber 32. On one side, the hot exhaust gas, which is free of fuel, from the afterburning chamber 32, flows through this cathode gas heat exchanger. The hot exhaust gas, which is free of fuel, supplies heat. On the other side, the cathode gas heat exchanger 36 is connected with the blower 16 by way of a fresh-air feeding pipe 37 and with the cathode gas inlet 23 of the fuel cell 20. As a result, fresh air flows through the cathode gas heat exchanger 36 and, in the cathode gas heat exchanger 36, absorbs heat from the hot exhaust gas having no fuel and thus arrives in the fuel cell 20 in a preheated condition.

The exhaust leaving the cathode gas heat exchanger 36 has a temperature of approximately 200-300° C., which represents a very low temperature level.

According to a particularly preferred embodiment of the invention, the reformer 10 and the reformate gas heat exchanger 13 are combined to form the reformer device 2, and the fuel cell stack 10, the anode gas heat exchanger 26, the afterburning chamber 32 and the cathode gas heat exchanger 36 are combined to form the fuel cell device 3 in a module-type manner.

Furthermore, the first three-way valve 29, the second three-way valve 33 and, if required, the blower 30 may be combined in a module-type manner to form the distribution device 4. In this case, the resulting modules, in a simple manner, only have to be connected by low-temperature pipes since hot gas, that is, gas having a temperature of, for example, above 400° C., does not come from any of the module outlets. Thus, the reformer device 2, the fuel cell device 3 and the distribution device 4 may be positioned with a high variability, for example, in a motor vehicle, and may be connected by means of cost-effective pipes, which may be produced at low construction and manufacturing expenditures, for forming the energy conversion system 1.

An energy conversion system 1 according to the invention also has the advantage that, particularly during a variable reformer operation between the reformer and heater operating points, the installation of an additional heater, or of an auxiliary heater, can be completely eliminated and the comfort characteristics of an additional heater and an auxiliary heater as well as the possibility of an engine preheating during the cold start operation exist nevertheless.

The electric power is provided by the fuel cell 20 at terminals 40a, 41a.

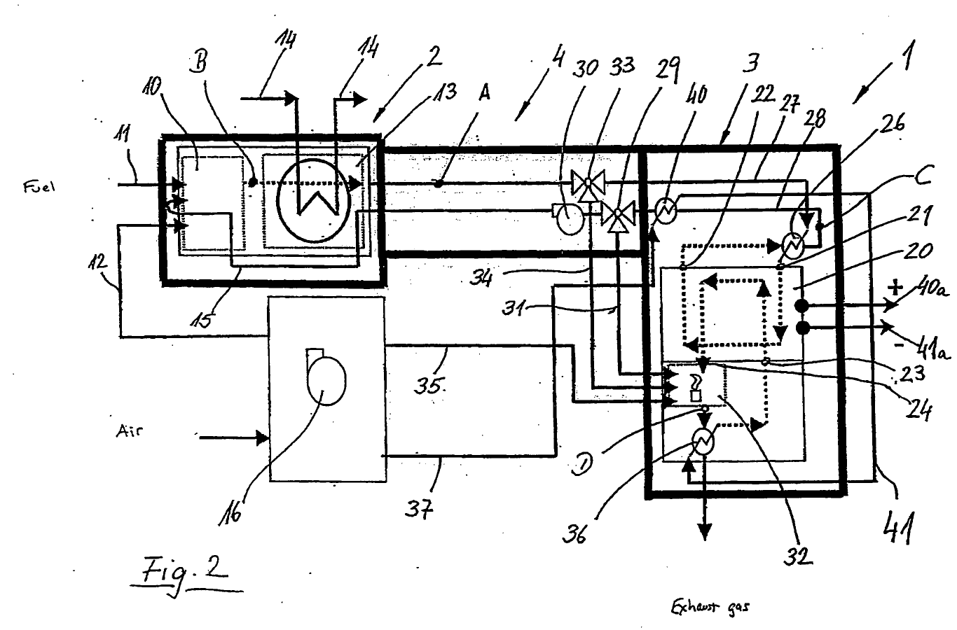

According to another embodiment of the invention (FIG. 2), another heat exchanger, such as an additional heat exchanger 40, is arranged between the anode gas heat exchanger 26 and the first three-way valve 29. On the one hand, temperature-reduced anode exhaust gas, which has left the anode gas heat exchanger 26, flows through the additional heat exchanger 40. On the other hand, the additional heat exchanger 40 is connected with the fresh-air feeding pipe 37, so that heat of the anode exhaust gas is supplied to the fed fresh air, which therefore flows by way of a bridge pipe 41 connecting the additional heat exchanger 40 with the input of the cathode heat exchanger 36. Thus, another temperature reduction of the residual reformate gas in the residual reformate gas pipe 15, 28 may be reached and, in addition, a preheating of the fresh cathode air may be achieved before it is supplied to the cathode heat exchanger 36.

In the case of the energy conversion system according to the invention, it is a particular advantage that, as a result of the reformer device 10 according to the invention, a multiple use of components may be implemented because of the modular construction, so that the components need only be insignificantly modified for different applications. This results in a high integration capability of these components into the most varied vehicles since it becomes easily possible to standardize the interfaces and the coupling points, respectively. The individual component parts of the energy conversion system can thereby be manufactured in considerably larger piece numbers, which also reduces costs.

Furthermore, the energy conversion system according to the invention permits the complete elimination of additional heaters and auxiliary heaters, without any loss of comfort, or during cold-starting features of the driving engine.

The energy conversion system according to the invention provides a highly efficient power supply with a coupled heat utilization at an extremely high efficiency, which is still increased by recirculation measures of anode exhaust gas. It is particularly advantageous that, in the entire energy conversion system, the components or pipes carrying hot gas may be integrated in modules, so that connections between the modules may be constructed in a simple manner without the use of high-temperature components.

Furthermore, as a result of the module-type construction of the reformer device, of the fuel cell device, and of the distribution device, the energy conversion system according to the invention may be adapted with high flexibility to different installation space conditions in different vehicles.

It is another important advantage of the invention that, until an optimal operating point of the reformer 10 has been reached, reformate gas of a possibly lower quality does not necessarily have to be guided through the fuel cell 20, but rather may be guided by way of the second three-way valve 33 directly into the afterburning chamber 32 so that damage to, or contamination of, the fuel cell 20 is avoided.

It is another important advantage that the reformer device and the fuel cell device may also be operated independently of one another. In particular, the fuel cell device may also be operated without a reformer device if another source of reformate is present in the vehicle for other reasons.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle having an energy conversion system, comprising:
a reformer device;
a fuel cell device, which is arranged behind the reformer device, the reformer device including a reformer and having at least one fuel feeding pipe and one air feeding pipe;
a reformate heat exchanger arranged between the reformer and the fuel cell device, which reformate heat exchanger transfers heat from a hot reformate gas to a fluid, by which one of an auxiliary heater and an additional heater of the motor vehicle is operable, or by which a driving engine of the motor vehicle is preheatable.

2. The motor vehicle having an energy conversion system according to claim 1, wherein the reformer is coupled with a residual reformate pipe.

3. The motor vehicle having an energy conversion system according to claim 2, wherein the residual reformate pipe is an anode exhaust gas pipe.

4. The motor vehicle having an energy conversion system according to claim 1, wherein the fuel cell device includes an anode gas heat exchanger, which transfers heat from a hot anode exhaust gas to a fresh anode gas.

5. The motor vehicle having an energy conversion system according to claim 2, wherein the fuel cell device includes an anode gas heat exchanger, which transfers heat from a hot anode exhaust gas to a fresh anode gas.

6. The motor vehicle having an energy conversion system according to claim 1, wherein the fuel cell device has at least one fuel cell to which an afterburning chamber is assigned on at least one of an anode exhaust gas side and a cathode exhaust gas side.

7. The motor vehicle having an energy conversion system according to claim 6, further comprising:
a cathode gas heat exchanger arranged behind the afterburning chamber, which cathode gas heat exchanger transfers beat from exhaust gas of the afterburning chamber to a fresh cathode gas.

8. The motor vehicle having an energy conversion system according to claim 7, wherein at least the fuel cell, the anode gas heat exchanger, the afterburning chamber and, if required, the cathode gas heat exchanger, are combined in a module-type manner to form the fuel cell device.

9. The motor vehicle having an energy conversion system according to claim 1, wherein the reformer and the reformate heat exchanger are combined in a module-type manner to form the reformer device.

10. The motor vehicle having an energy conversion system according to claim 8, wherein the reformer and the reformate heat exchanger are combined in a module-type manner to form the reformer device.

11. The motor vehicle having an energy conversion system according to claim 1, further comprising:
a first three-way valve, a second three-way valve, and a blower, which are combined in a module-type manner to form a distribution device for the energy conversion system.

12. The motor vehicle having an energy conversion system according to claim 10, further comprising:
a first three-way valve, a second three-way valve, and a blower, which are combined in a module-type manner to form a distribution device for the energy conversion system.

13. The motor vehicle having an energy conversion system according to claim 12, wherein an additional heat exchanger is arranged between the anode gas heat exchanger and the first three-way valve, which additional heat exchanger transfers heat from the anode exhaust gas to the fresh cathode gas.

14. The motor vehicle having an energy conversion system according to claim 6, further comprising:
a central air supply unit, which supplies fresh air to the reformer, the afterburning chamber and the fuel cell.

15. The motor vehicle having an energy conversion system according to claim 1, further comprising:
adjustment devices for adjusting an air/fuel ratio in the reformer.
